(19) United States
(12) Patent Application Publication
(10) Pub. No.: US 2015/0257337 A1
(43) Pub. Date: Sep. 17, 2015

(54) Picking Unit, Harvesting Attachment and Harvester for Corn or Similar

(71) Applicant: Franz SCHRATTENECKER, Eggerding (AT)

(72) Inventor: Franz Schrattenecker, Eggerding (AT)

(21) Appl. No.: 14/415,046

(22) PCT Filed: Jul. 3, 2013
(86) PCT No.: PCT/EP2013/001946

§ 371 Date: Apr. 15, 2015

(30) Foreign Application Priority Data
Jul. 16, 2012 (DE) 10 2012 014 085.1

(51) Int. Cl. A01D 45/02; A01D 57/22; A01D 82/02; A01D 41/12

(52) U.S. Cl. CPC A01D 45/028; A01D 41/12; A01D 57/22; A01D 82/02

(57) ABSTRACT

A picking unit for corn or the like for a harvesting attachment for a harvesting machine comprises a picking gap (10) on which two counter-rotating draw-in rollers (26, 27) are arranged. To improve such picking unit, one draw-in roller (26) has a portion (28) with a spiraling cutting edge (29) (FIG. 16).

The invention relates to a picking unit for corn or the like for a harvesting attachment for a harvesting machine. The invention furthermore relates to a harvesting attachment for a harvesting machine and to a harvesting machine, in particular a combine-harvester.

The picking unit for corn or the like comprises a picking gap on which two counter-rotating draw-in rollers are arranged.

Such picking unit is known from DE 299 09 358 U1.

It is the object of the invention to improve the chopping effect in a picking unit of the type mentioned above.

According to the invention, this object is solved by the features of claim 1. The picking gap extends in horizontal direction or in approximately horizontal direction with an inclination from the bottom front to the top rear. It extends in direction of the direction of movement of the harvesting machine, which in particular can be a combine-harvester. The picking unit is arranged in front of the harvesting machine in direction of movement.

At the picking gap two counter-rotating draw-in rollers are arranged. The draw-in rollers are located on both sides of the picking gap. They extend substantially parallel to the picking gap and at a distance from each other. The draw-in rollers are located below the picking gap.

The picking unit can comprise further components. In particular, it can comprise rotating cutting knives. The cutting knives rotate about a vertically or substantially vertically extending axis, i.e. in a horizontal or substantially horizontal plane. The cutting knives rotating in this way form a horizontal chopper. They are located below the draw-in rollers.

The picking unit furthermore can include draw-in chains. The draw-in chains are arranged on both sides of the picking gap. They are located above the picking gap. These are counter-rotating chains which rotate in a substantially horizontal plane extending parallel to the picking gap. On the draw-in chains carriers are provided, which protrude into the region above the picking gap and there are moving from front to rear.

The picking unit also can include further rotating cutting knives, which rotate about a horizontally or substantially horizontally extending axis. The cutting knives thus rotate in a vertical or substantially vertical plane. They form a vertical chopper. The further rotating cutting knives are arranged below the picking gap and behind the cutting knives which form the horizontal chopper.

According to the invention, a draw-in roller has a portion with a spiraling cutting edge. This draw-in roller also can be referred to as knife roller. The spiraling cutting edge improves the chopping effect.

In particular, it can thereby be achieved that the stalk of the corn plant or other plant is split centrally, in fiber direction. This can lead to the fact that the organic material will decay more easily. In particular, it can be prevented that insects which are problematic for the cultivation of the corn plant or other plant can multiply and/or overwinter in the interior of the stalk.

Advantageous developments are described in the sub-claims.

It is advantageous when the other draw-in roller has a portion with a spiraling cutting edge. The chopping effect can even further be improved thereby.

It is, however, also possible that the other draw-in roller has a portion with a spiraling strip. This draw-in roller also can be referred to as strip roller. The strip does not have a tapered cross-section which can be sharpened, like the spiraling cutting edge, but a cross-section ending blunt. This can also lead to a further improvement of the chopping effect.

It is advantageous when the spiraling cutting edge of the one draw-in roller and the spiraling cutting edge of the other draw-in roller penetrate each other. The outside diameters of the portions of the cutting edges overlap each other. At the same time, the arrangement is made such that the spaced portions of the cutting edge of the one draw-in roller penetrate into the gaps between the spaced portions of the cutting edge of the other draw-in roller, so that they cannot collide with each other and do not hinder each other. The rotational movements of the draw-in rollers are synchronized, in order to continually ensure this absence of collisions.

Correspondingly, it is advantageous when the spiraling cutting edge of the one draw-in roller and the spiraling strip of the other draw-in roller penetrate each other in a corresponding way.

According to another advantageous development, flutings are present between the spaced portions of the spiraling strip of the other draw-in roller. The chopping effect can further be improved thereby.

One or both of the draw-in rollers can have a smooth draw-in region.

Instead or in addition, one or both of the draw-in rollers can have a draw-in region with a spiraling strip.

The draw-in region of one or both of the draw-in rollers can be designed cone-shaped. The cone flares in direction to the rear.

The invention furthermore relates to a harvesting attachment for a harvesting machine with a frame which is characterized by one or more picking units according to the invention.

The invention finally relates to a harvesting machine, in particular a combine-harvester which is characterized by a harvesting attachment according to the invention.

Exemplary embodiments of the invention will be explained in detail below with reference to the attached drawing, in which:

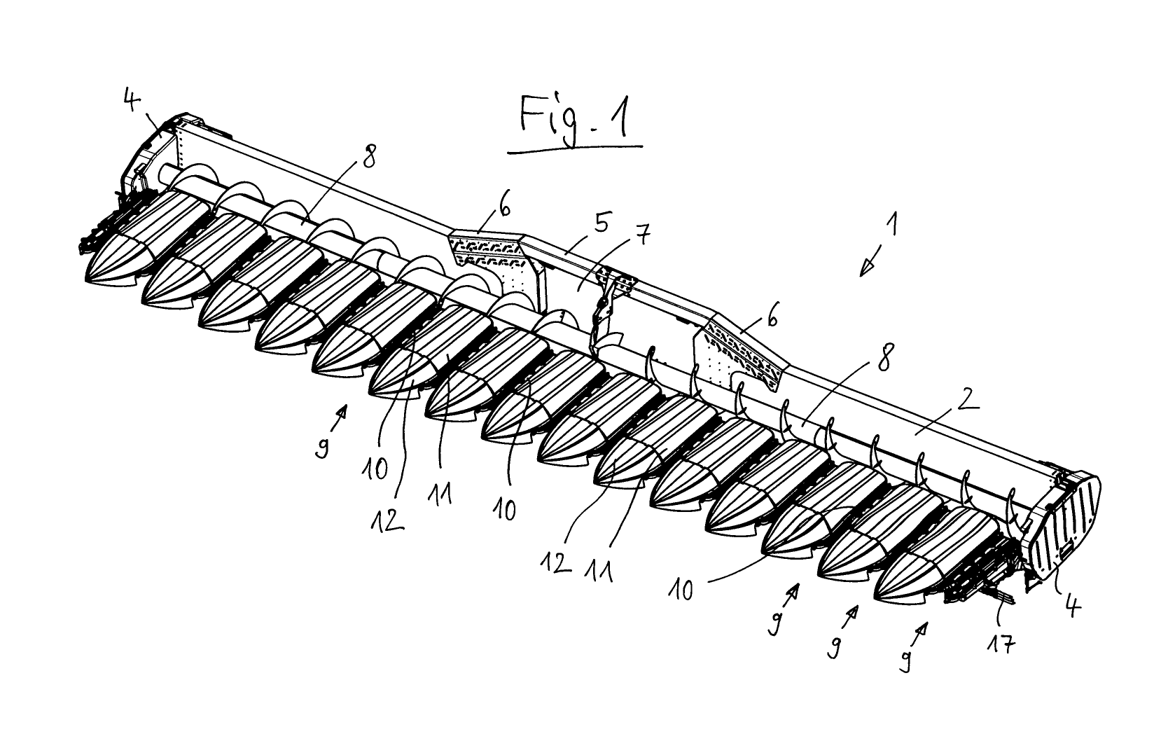

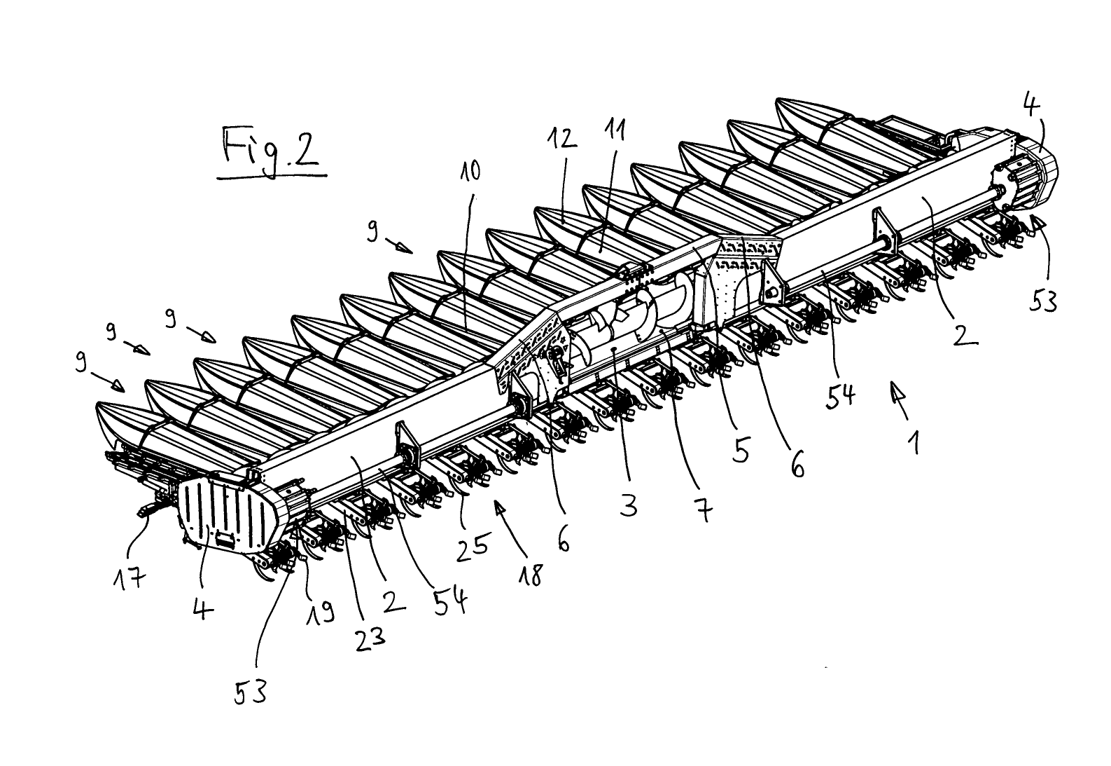

FIG. 1 shows a harvesting attachment for a harvesting machine with a frame and several picking units for corn or the like in a perspective view obliquely from the top front,

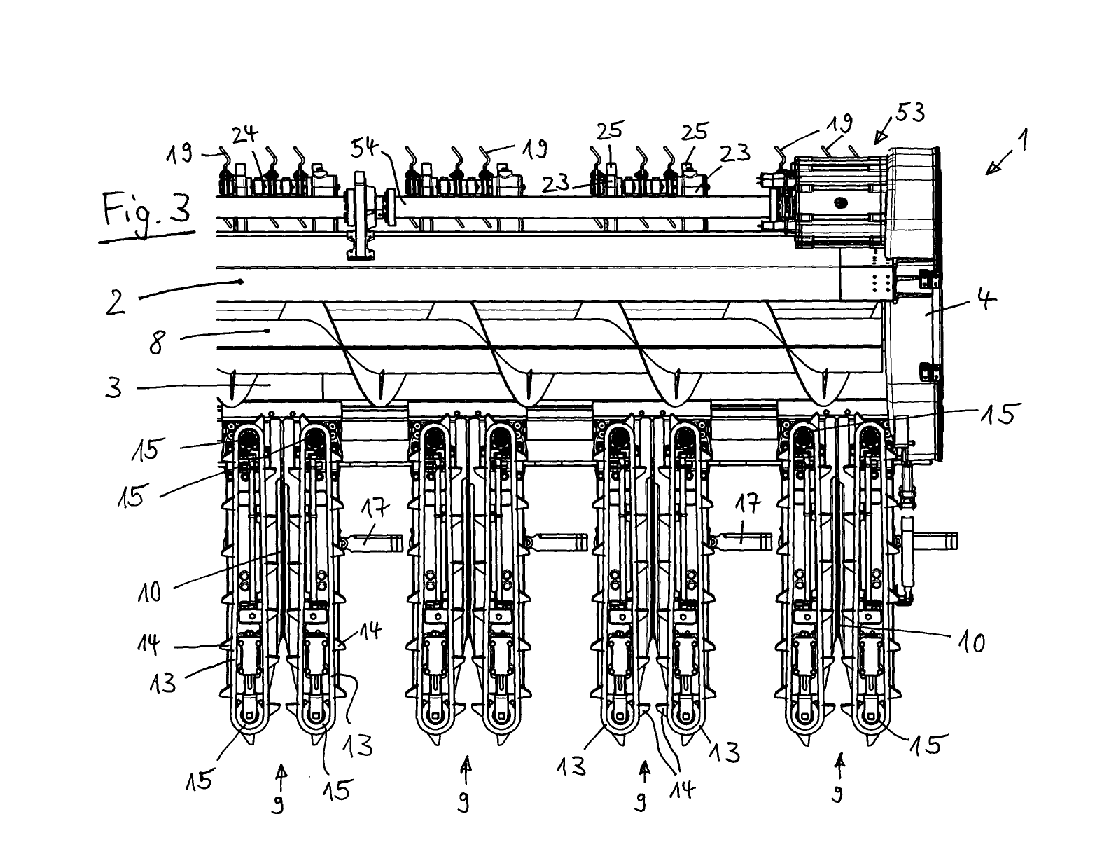

FIG. 2 shows the harvesting attachment according to FIG. 1 in a perspective view obliquely from the top rear,

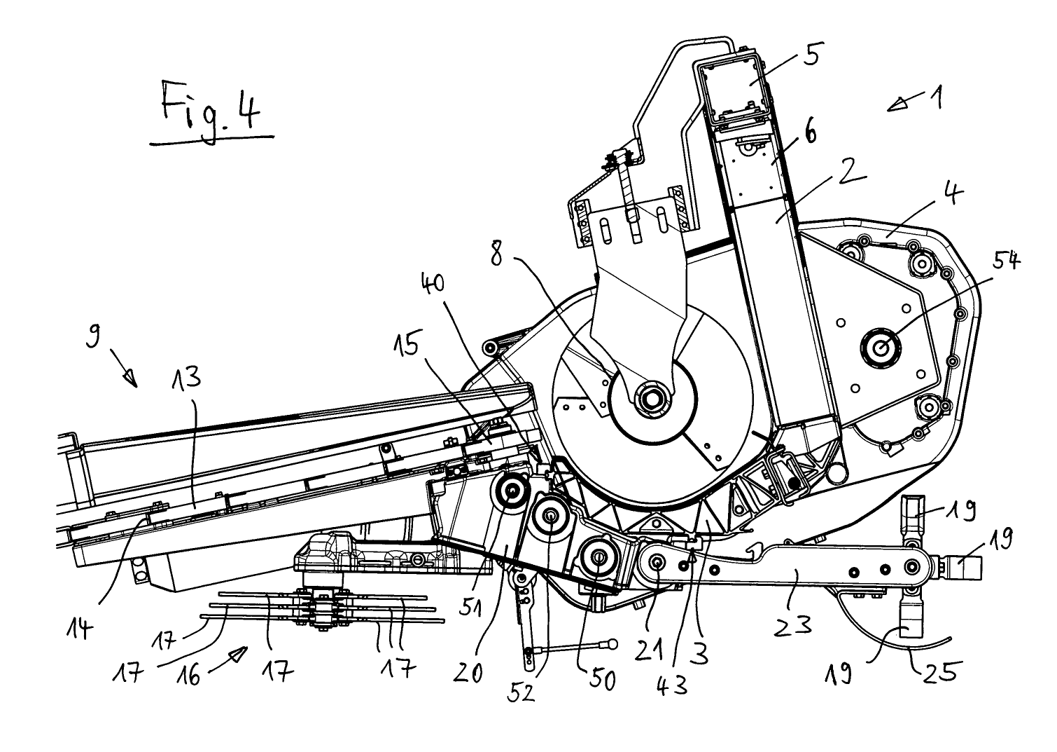

FIG. 3 shows a part of the harvesting attachment according to FIGS. 1 and 2 without covering hoods in a view from above,

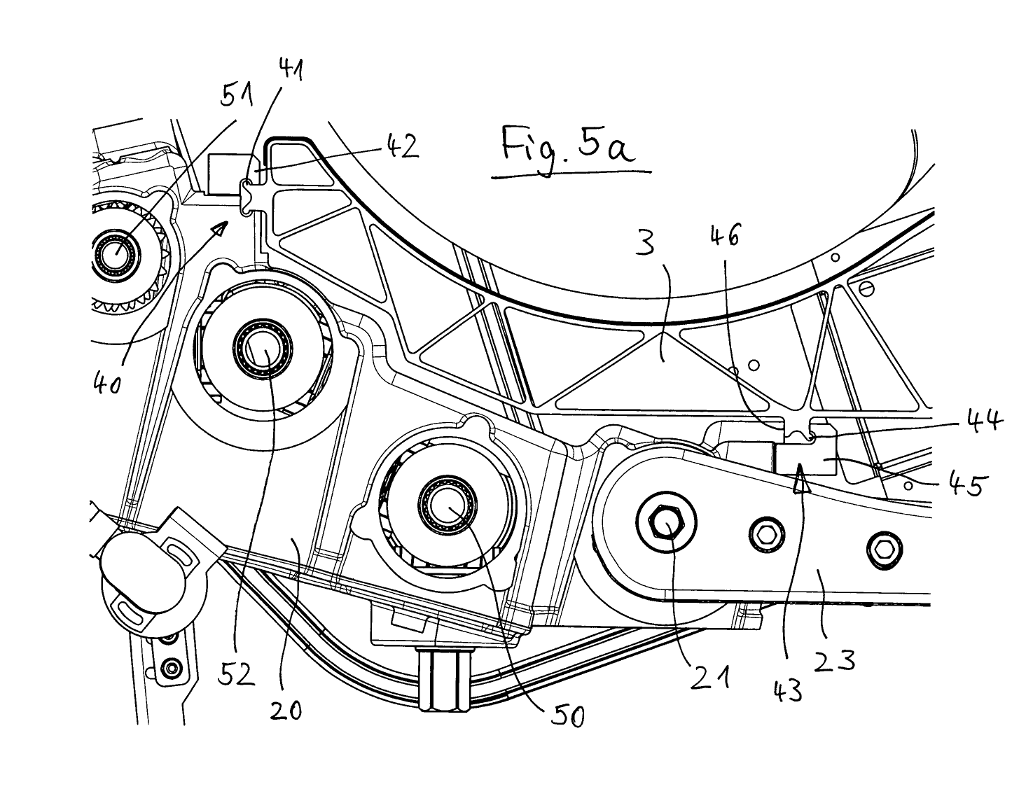

FIG. 4 shows the harvesting attachment according to FIGS. 1 to 3 in a side view,

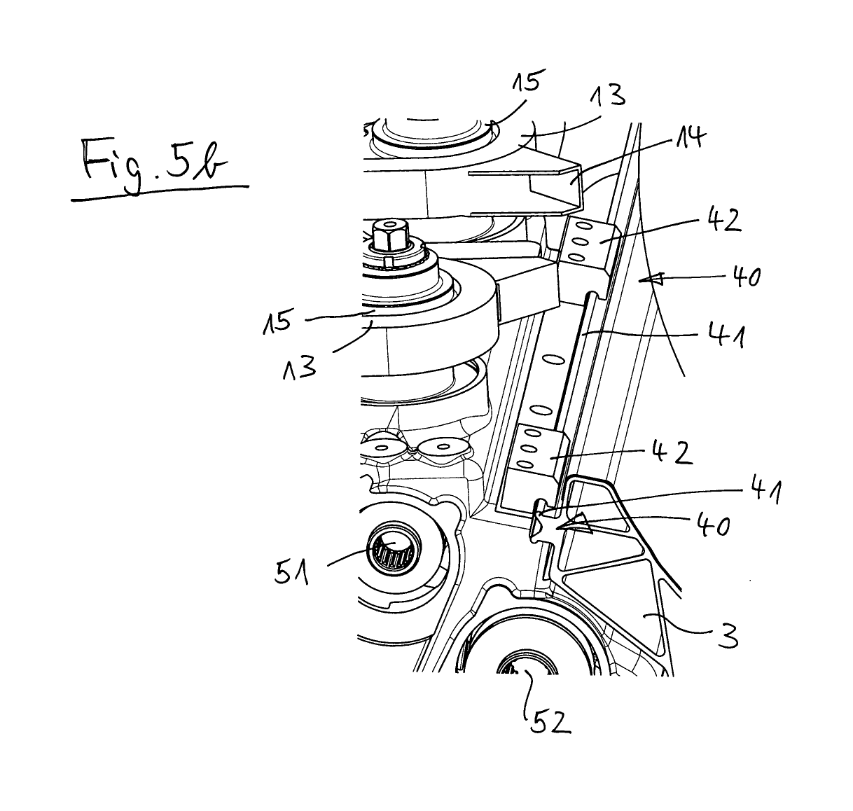

FIG. 5a shows a detail from FIG. 4 in a side view,

FIG. 5b shows a detail from FIG. 5a in a perspective view,

FIG. 5c shows another detail from FIG. 5a in a perspective view,

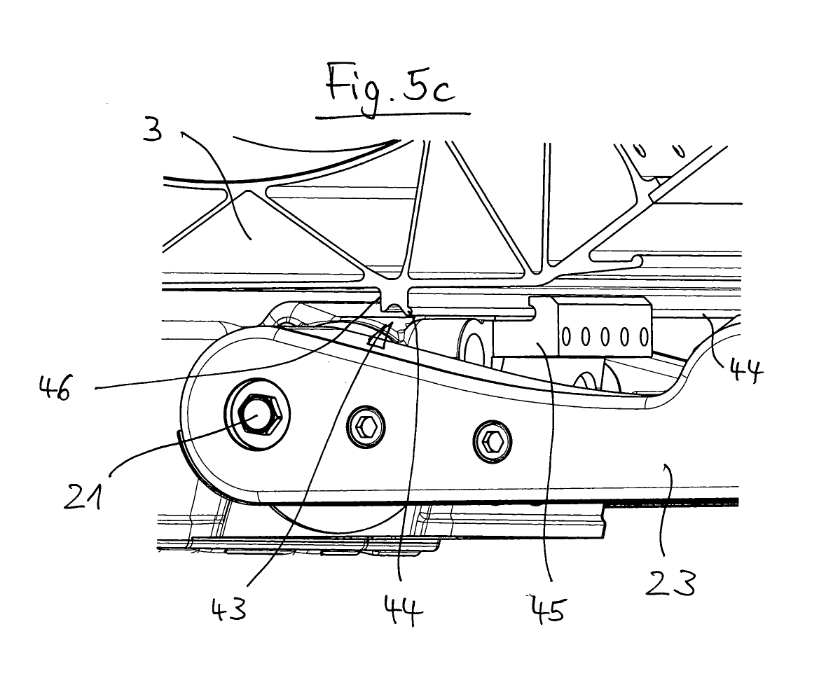

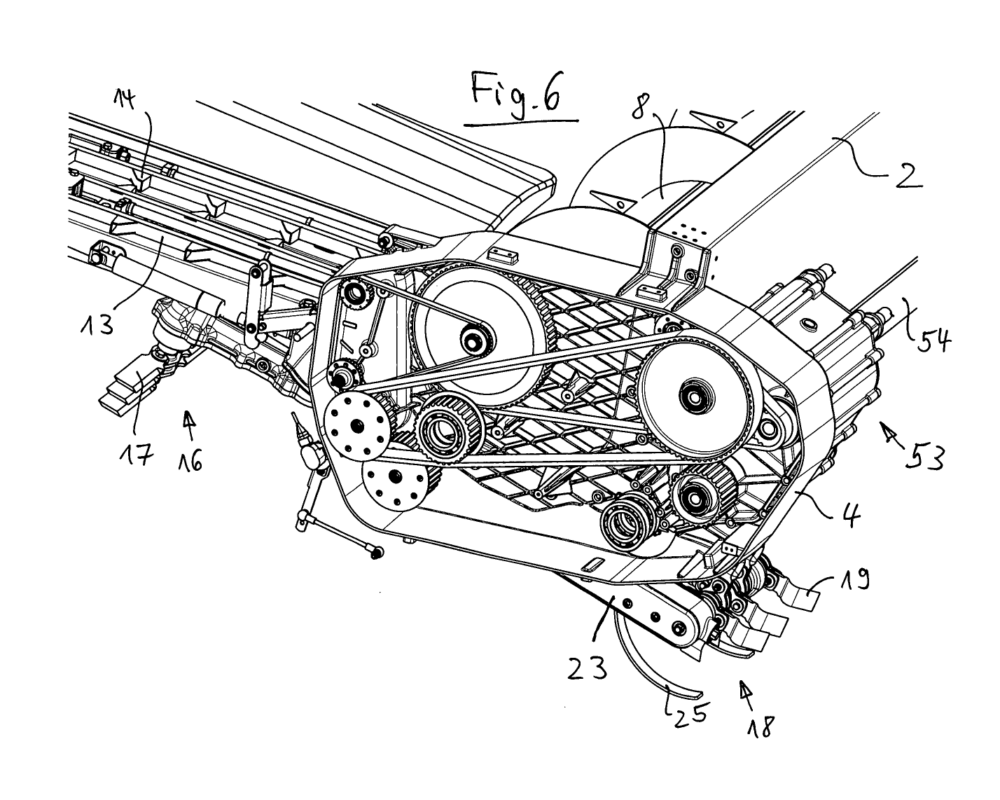

FIG. 6 shows an end of the harvesting attachment according to FIGS. 1 to 5 with a primary gear in a perspective view,

FIG. 7 shows the primary gear according to FIG. 6 in a perspective view,

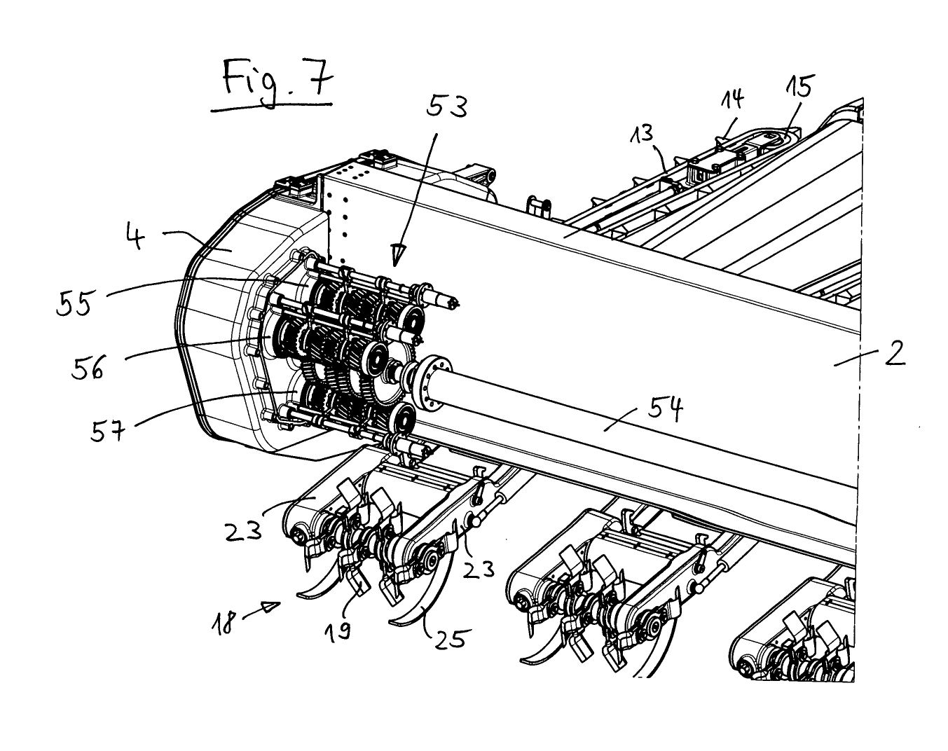

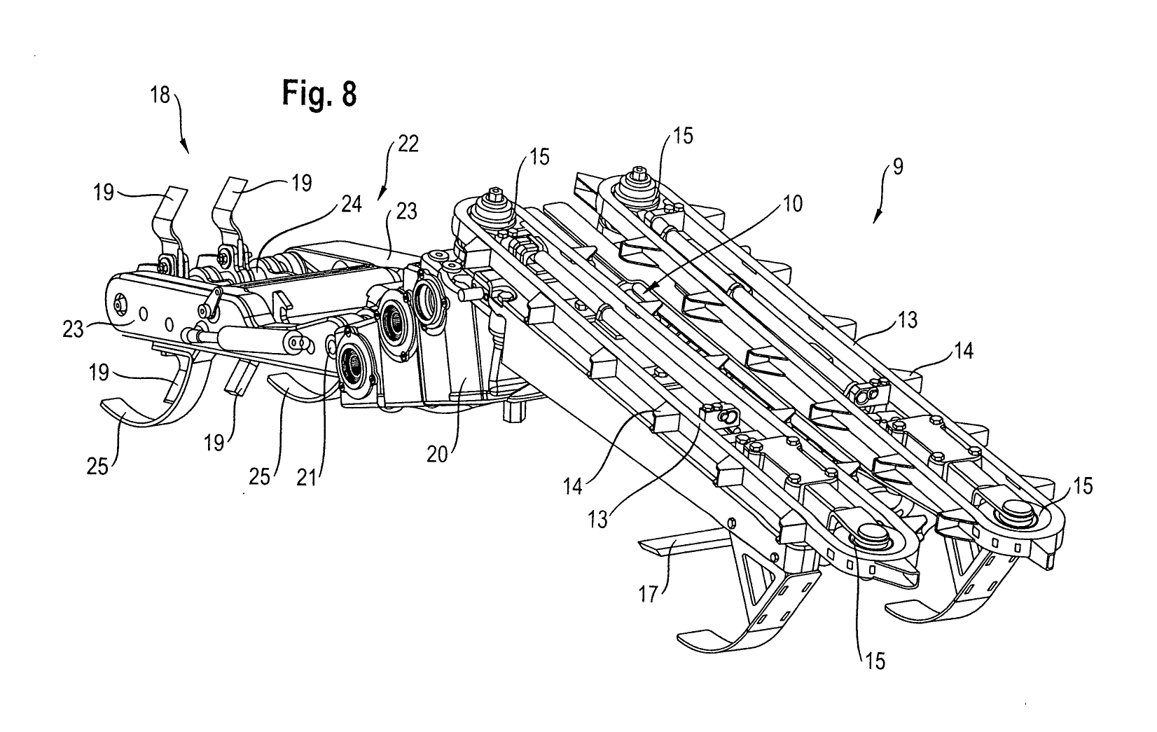

FIG. 8 shows a picking unit of the harvesting attachment in a perspective view obliquely from the top front,

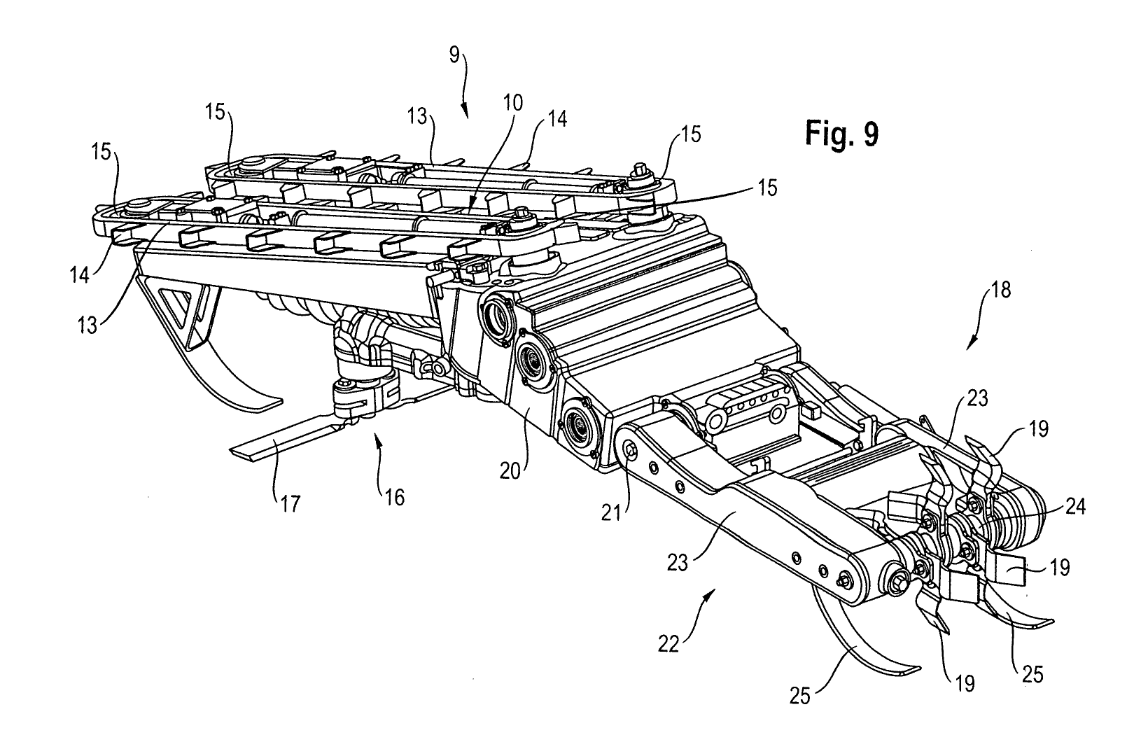

FIG. 9 shows the picking unit according to FIG. 8 in a perspective view obliquely from the top rear,

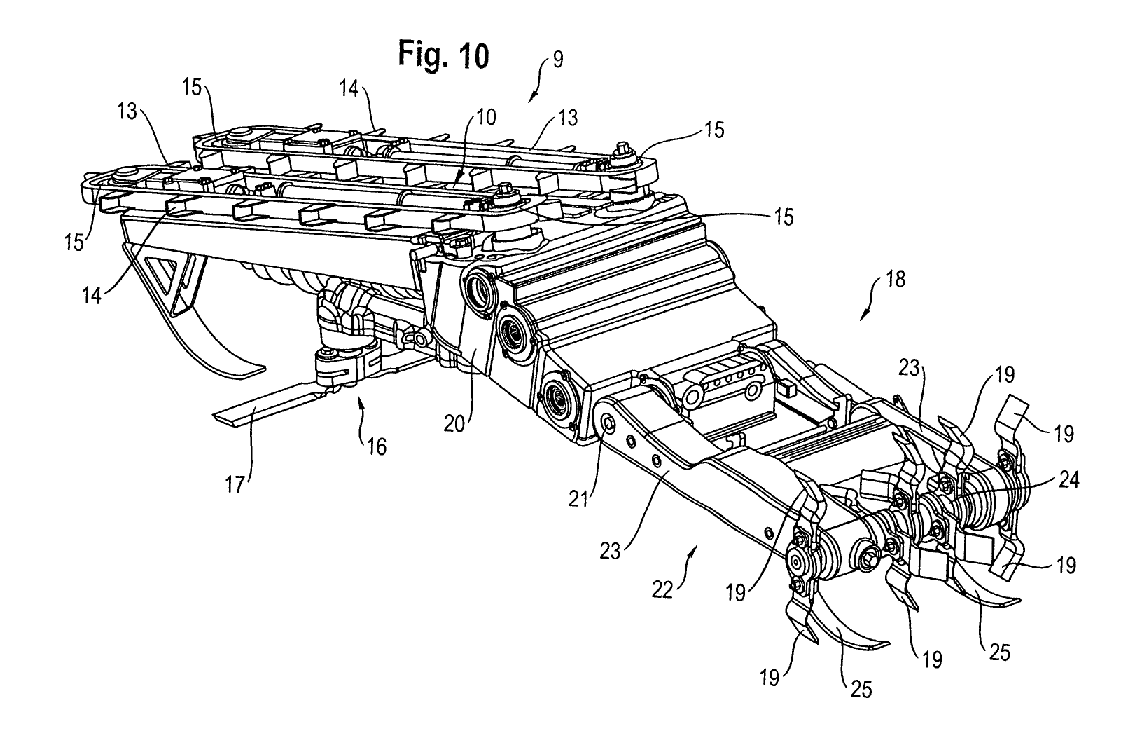

FIG. 10 shows a modification of the picking unit according to FIGS. 8 and 9 in a perspective view corresponding to FIG. 9,

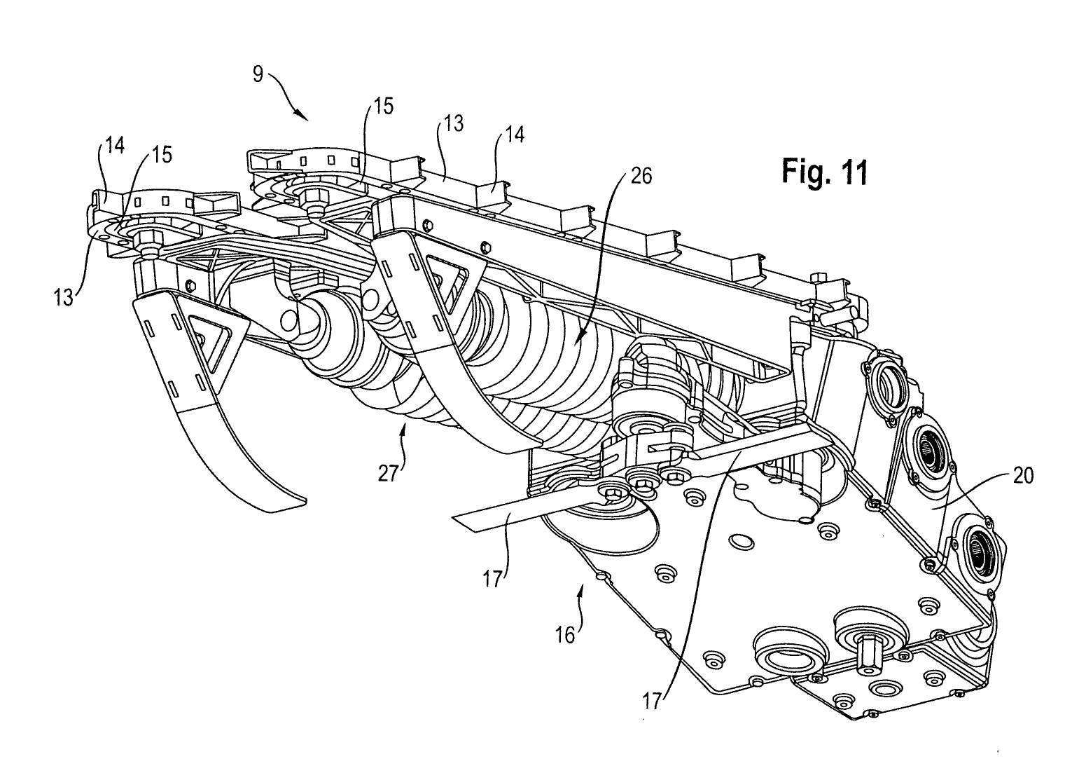

FIG. 11 shows a part of the picking unit according to FIGS. 8 to 10 in a perspective view obliquely from the bottom front with two draw-in rollers formed as knife rollers and a horizontal chopper with a rotor with cutting knives in one plane,

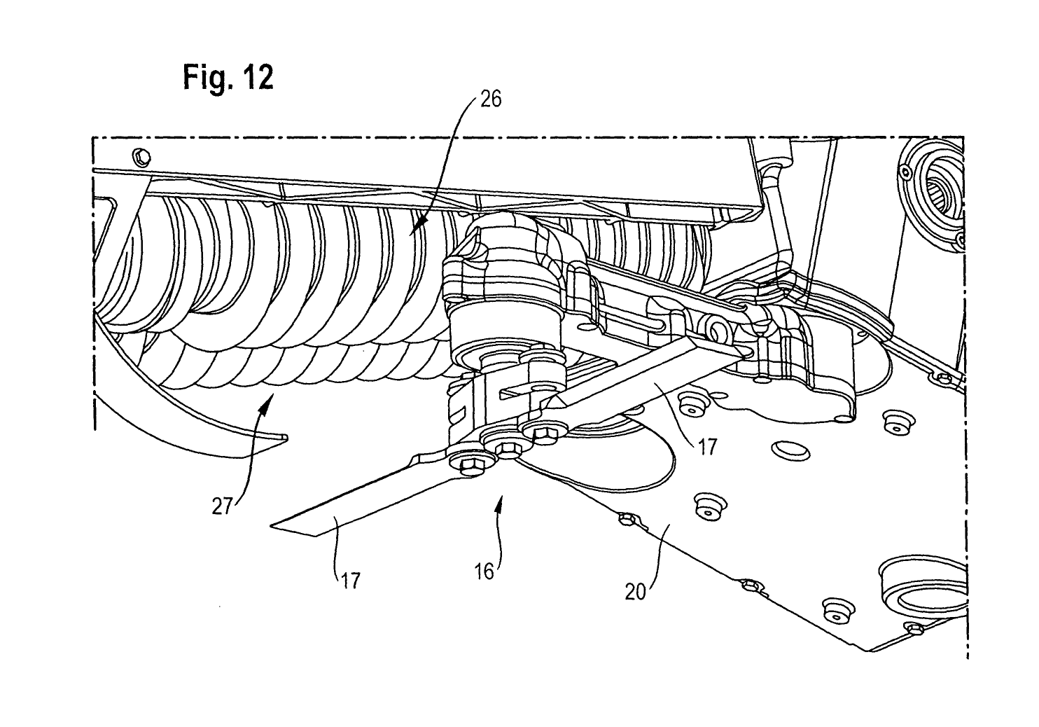

FIG. 12 shows the picking unit according to FIG. 11 in an enlarged perspective representation,

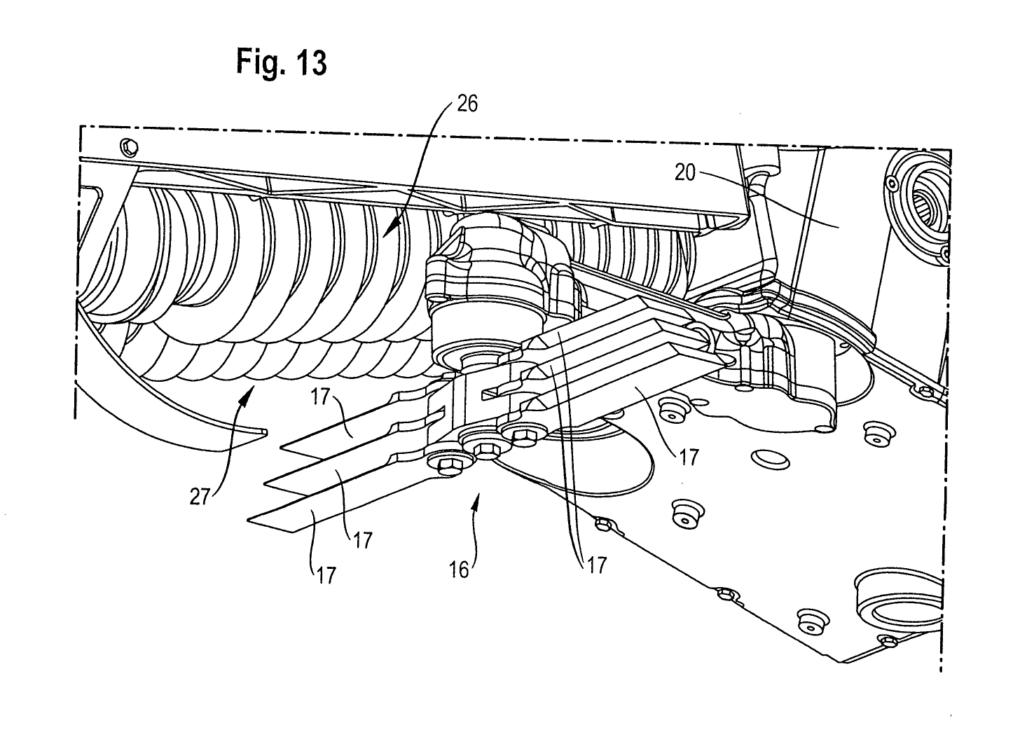

FIG. 13 shows a modification of the picking unit according to FIGS. 11 and 12 with a horizontal chopper with one rotor with cutting knives in three planes,

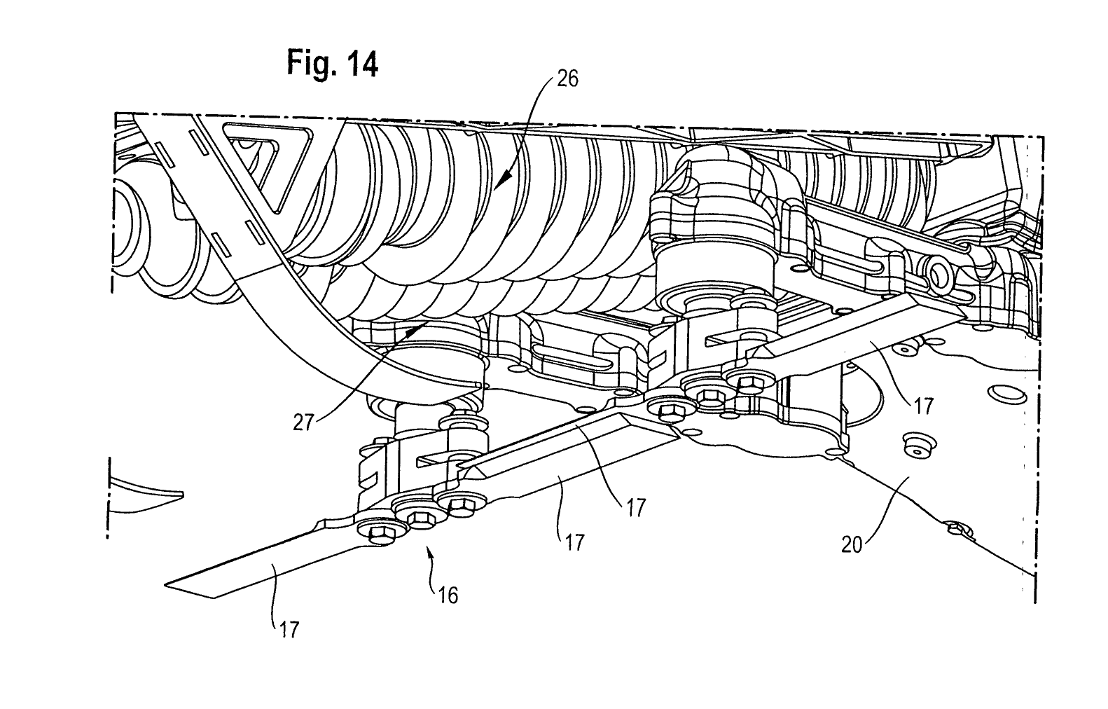

FIG. 14 shows a modification of the picking unit according to FIGS. 11 and 12 with a horizontal chopper with two rotors with cutting knives in one plane each,

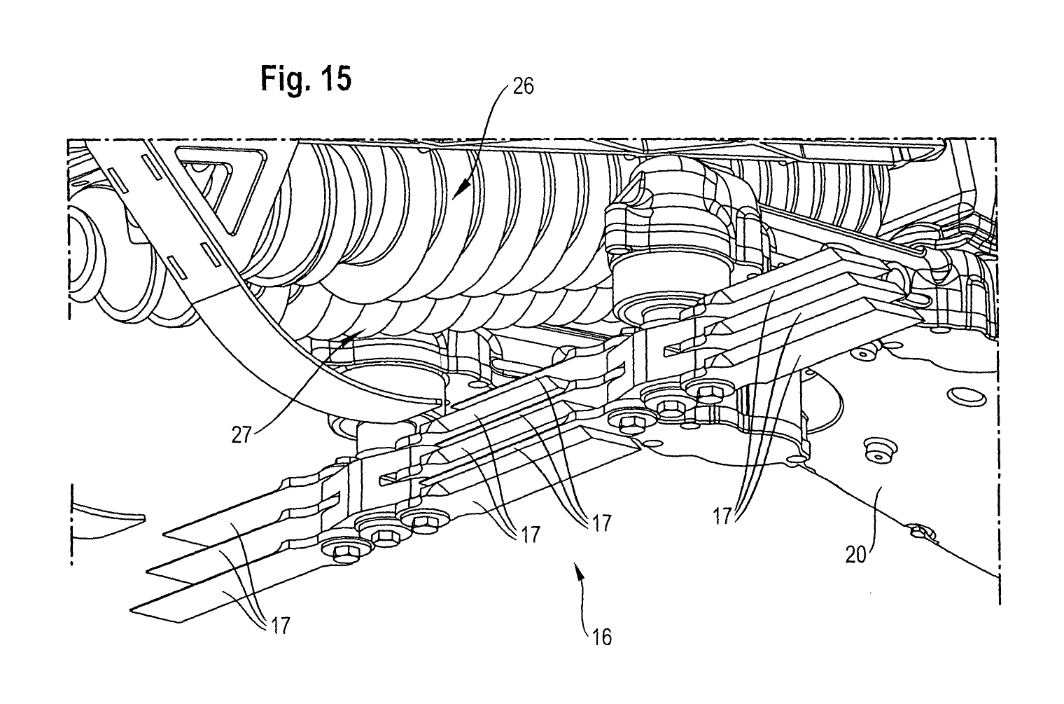

FIG. 15 shows a modification of the picking unit according to FIG. 14 with a horizontal chopper with two rotors with cutting knives in three planes each,

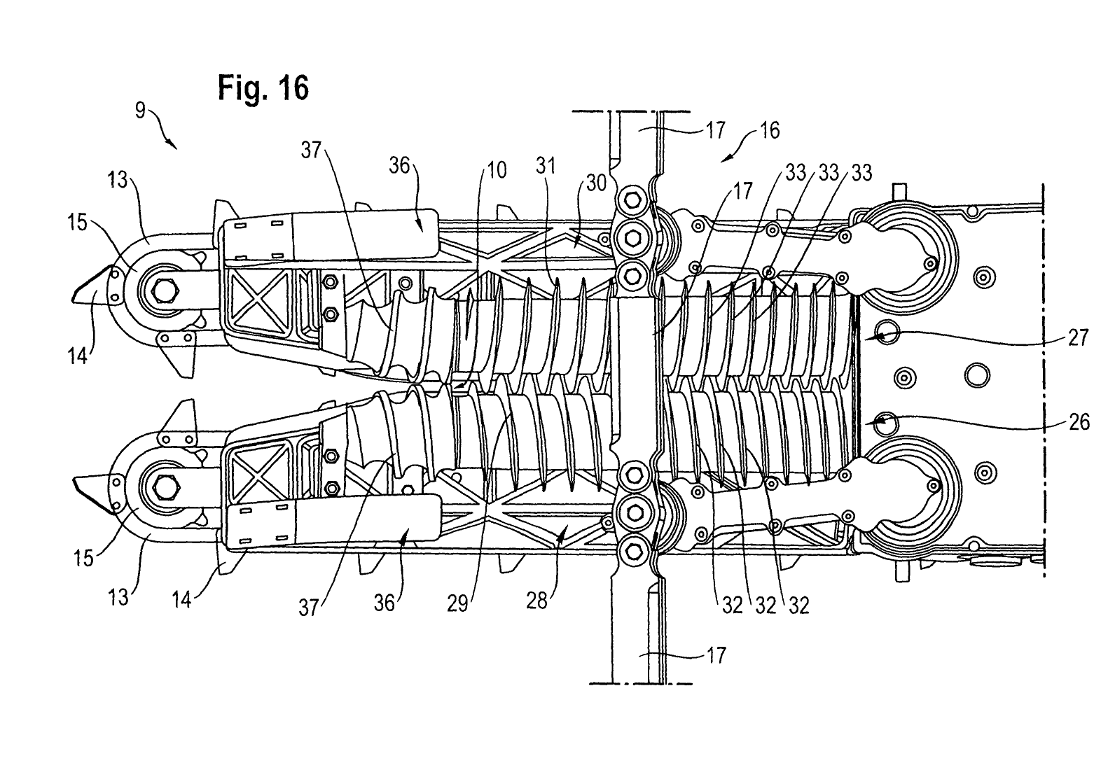

FIG. 16 shows the picking unit according to FIGS. 8 to 15 in a view from below, and

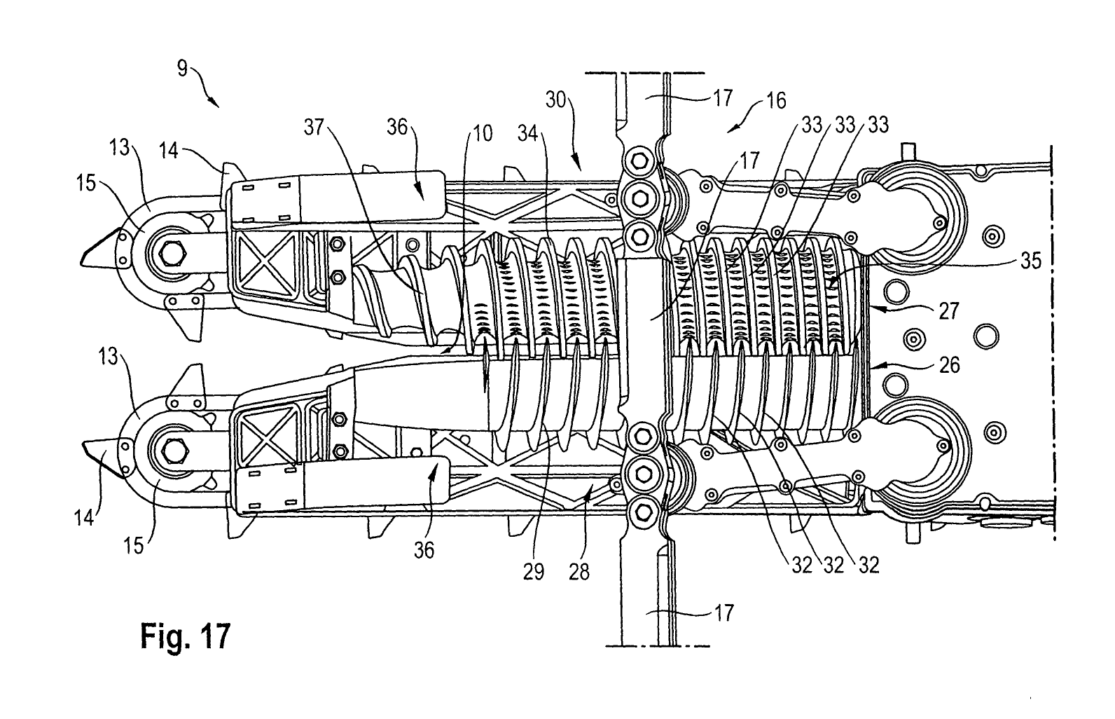

FIG. 17 shows a modification of the picking unit according to FIG. 16 with one draw-in roller formed as knife roller and one formed as strip roller.

The harvesting attachment shown in FIGS. 1 and 2 for a harvesting machine, in particular for a combine-harvester, comprises a frame 1 which includes a rear wall 2 and a bottom wall 3. The frame has an L-shaped angular form. The rear wall 2 substantially extends in vertical direction, and the bottom wall 3 substantially extends in horizontal direction.

The longitudinal extension of the frame 1 corresponds to the working width. The frame 1 includes side boxes 4 at its ends. In the middle of the frame 1 the rear wall 2 is provided with an elevation 5 which extends on the extension of the rear wall 2 and includes lateral bevels 6.

In the middle of the rear wall 2 there is furthermore provided a through opening 7 which on both sides is defined by the side walls 2 as well as by the bottom wall 3 and the elevation 5. The through opening 7 can serve for mounting the frame 1 on the harvesting vehicle. Furthermore, the crop can be conveyed through the through opening 7 from the front side of the frame 1 to the harvesting vehicle. For conveying the crop, a conveying screw 8 is present in the frame, which is located in the region of transition from the rear wall 2 to the bottom wall 3.

The frame 1 is formed as continuously cast profile, preferably as continuously cast light-metal profile of aluminum or of a material which contains aluminum. To the bottom wall 3 of the frame 1 several picking units 9 for corn or the like are attached. The picking units 9 each comprise a picking gap 10 which extends from the bottom front to the top rear. The picking units 9 are arranged parallel to each other and at a distance from each other, preferably each at the same distance.

Between two adjacent picking units 9 a covering hood 11 each is provided. At its front end, each covering hood 11 has a tapered inlet region 12 flaring towards the rear. The picking gaps 10 of adjacent picking units 9 adjoin the inlet regions 12 of adjacent covering hoods 11.

FIG. 3 shows an end of the frame 1 and four picking units 9 from which the covering hoods 11 have been removed. Each picking unit 9 comprises two draw-in chains 13 which are arranged on both sides of the picking gap 10. They are located above the picking gap 10. Each draw-in chain 13 endlessly runs around two rollers 15, which are rotatably mounted about approximately vertical axes inclined towards the front, so that the draw-in chains 13 revolve in opposite directions in approximately horizontal planes inclined towards the front. The sides of the draw-in chains 13 facing each other extend parallel to each other and at a distance from each other. They furthermore extend parallel to and at a distance from the picking gap 10 from front to rear. On the draw-in chains 13 carriers 14 are provided, which protrude into the region above the picking gap 10 and there are moving from front to rear.

As shown in FIG. 4, each picking unit 9 comprises a horizontal chopper 16. The horizontal chopper 16 is located below the picking gap 10 and below the draw-in chains 13. It comprises cutting knives 17 which rotate about a vertical axis in a horizontal plane. In the embodiment according to FIG. 4, the cutting knives 17 are arranged in three planes located one above the other, spaced from each other and parallel to each other.

As shown in particular in FIGS. 8 to 10, each picking unit 9 comprises a vertical chopper 18 which includes cutting knives 19 that rotate about a horizontally extending axis in a vertical plane. The vertical chopper is arranged below the picking gap and behind the picking gap and behind the horizontal chopper.

Each picking unit 9 comprises a housing 20. The vertical chopper 18 is pivotally mounted on the housing 20 about a horizontal axis 21. The horizontal axis 21 is located at the rear end of the housing 20.

The vertical chopper 18 has a frame 22 which comprises two outer longitudinal struts 23. The longitudinal struts 23 extend parallel to each other and at a distance from each other. They extend from the horizontal axis 21 to the rear.

In the ends of the longitudinal struts 23 a shaft 24 is mounted, to which the cutting knives 19 are attached. The cutting knives 19 can be suspended in pendulum fashion about horizontal axes.

The shaft 24 of the vertical chopper 18 is driven by a belt drive which is arranged in a longitudinal strut 23. The belt drive comprises a belt, preferably a toothed belt. The belt or toothed belt wraps around the shaft 24 and a drive shaft which extends coaxially to the horizontal axis 21.

In the embodiment according to FIGS. 8 and 9 the cutting knives 19 are arranged within the frame 22. In the embodiment according to FIG. 10 further cutting knives 19 are present, which are arranged outside the frame. For this purpose, the shaft 24 on both sides is extended to the outside via the longitudinal struts 23.

On the vertical chopper 18 sliding blocks 25 are mounted. The sliding blocks 25 are attached to the rear lower ends of the longitudinal struts 23 of the frame 22. They are designed arc-shaped. The sliding blocks 25 are convexly curved, so that they rest on the bottom in an arc-shaped manner. Due to the sliding blocks 25 and the pivotal mounting of the vertical chopper 18 on the housing 20 about the horizontal axis 21, each vertical chopper 18 of the adjacent picking units 9 can adapt to the ground profile. As a result, an adaptation of the respective vertical chopper 18 to the height of the ground also is possible, when the ground height varies along the longitudinal extension of the frame 1 which extends transversely to the direction of travel of the combine-harvester.

As shown in particular in FIGS. 11 to 17, each picking unit 9 includes two draw-in rollers 26, 27. The draw-in rollers 26 are located on both sides of the picking gap 10. They rotate in opposite directions about axes which extend parallel to each other and at a distance from each other. The axes of rotation of the draw-in rollers 26, 27 extend parallel to the picking gap 10 from the bottom front to the top rear. They are located below the picking gap 10.

A draw-in roller 26 has a portion 28 with a spiraling cutting edge 29. The cutting edge 29 has a tapered cross-section which can be sharpened.

In the embodiment according to FIG. 16, the other draw-in roller 27 also has a portion 30 with a spiraling cutting edge 31. The cutting edges 29, 31 penetrate each other. The outside diameters of the cutting edges 29, 31 overlap each other. The arrangement is made such that the spaced, adjacent portions 32 of the cutting edge 29 penetrate into the gaps between the spaced, adjacent portions 33 of the cutting edge 31 of the other draw-in roller 27, so that they cannot collide with each other and do not hinder each other. The rotational movements of the draw-in rollers 26, 27 are synchronized, in order to ensure this absence of collisions.

In the embodiment according to FIG. 17, the other draw-in roller 27 has a portion 30 with a spiraling strip 34. The strip 34 has a cross-section ending blunt. It substantially is a rectangular cross-section. The spiraling cutting edge 29 of the draw-in roller 26 and the spiraling strip 34 of the other draw-in roller 27 penetrate each other. The outside diameters of the cutting edge 29 and the strip 34 overlap each other. The arrangement is made such that the spaced, adjacent portions 32 of the cutting edge 39 penetrate into the gaps between the spaced, adjacent portions 33 of the strip 34 of the other draw-in roller 27, so that they cannot collide with each other and do not hinder each other. The rotational movements of the draw-in rollers 26, 27 are synchronized, in order to ensure this absence of collisions.

Between the portions 33 of the spiraling strip 34 of the other draw-in roller 27 flutings 35 are present. The flutings 35 are depressions or elevations which extend in longitudinal direction of the other draw-in roller 27 and which are spaced from each other in radial direction, preferably at the same distance.

The draw-in rollers 26, 27 each have a draw-in region 36. The draw-in regions 36 are located at the front ends of the draw-in rollers 26, 27. They are designed cone-shaped. The cone flares from front to the rear. At the rear end the diameter of the cones of the draw-in regions 36 corresponds with the diameter of the portions 28, 30 of the draw-in rollers 26, 27. The portions 28, 30 of the draw-in rollers 26, 27 extend from the rear ends of the draw-in regions 36 to the rear ends of the draw-in rollers 26, 27.

In the embodiment according to FIG. 16, both draw-in rollers 26, 27 have a draw-in region 36 with a spiraling strip 37. In the embodiment according to FIG. 17, the draw-in roller 26 has a smooth draw-in region 36. The other draw-in roller 27 has a draw-in region 36 with a spiraling strip 37. However, all other combinations also are possible. It is possible that in both embodiments both draw-in rollers 26, 27 have a smooth draw-in region 36, that in both embodiments the draw-in roller 26 has a smooth draw-in region 36 and the other draw-in roller 27 has a draw-in region 36 with a spiraling strip 37, that in both embodiments the draw-in roller 26 has a draw-in region 36 with a spiraling strip 37 and the other draw-in roller 27 has a smooth draw-in region 36, and that in both embodiments both draw-in rollers 26, 27 have a draw-in region 36 with a spiraling strip 37.

FIGS. 11 and 12 show a picking unit 9 with a horizontal chopper 16 which includes a rotor with two cutting knives 17 in one plane. In the exemplary embodiment according to FIG. 13 the picking unit 9 includes a horizontal chopper 16 with a rotor on which two cutting knives 17 each are arranged in three planes located one above the other, spaced from each other and parallel to each other. In the embodiment according to FIG. 14, the horizontal chopper 16 comprises two rotors with two cutting knives each in one plane each, wherein these planes are offset against each other in height, so that the knife circles overlapping each other cannot lead to a collision of the cutting knives 17. In the embodiment according to FIG. 15 the horizontal chopper 16 comprises two rotors with two cutting knives 17 each in three planes each, which are located one above the other, spaced from each other and parallel to each other. The knife planes of the two rotors are offset against each other in height, in order to avoid collisions of the cutting knives 17 whose knife circles overlap each other.

FIGS. 4 and 5 show the connection of a picking unit 9 to the frame 1. The picking unit 9 is releasably connected with the bottom wall 3 of the frame 1. For this purpose, the bottom wall 3 includes a horizontally extending vertical strip 40 which comprises an upwardly directed supporting strip 41. The vertical strip 40 is located at the front end of the bottom wall 3. A gripping strip 42 rests on the supporting strip 41. The gripping strip 42 has a groove on its underside, into which the supporting strip 41 engages with its upper end. The gripping strip 42 is releasably connected with the housing 20 of the picking unit 9 by screw bolts. The connecting point is located on the top side of the housing 20. The screw bolts extend in vertical direction. The vertical strip 40 can include a lower strip which is directed downwards. This strip and the supporting strip 41 can form a dovetail guide.

On the bottom wall 3 of the frame 1 there is furthermore provided a horizontally extending horizontal strip 43. The horizontal strip 43 is located on the underside of the bottom wall 3. It comprises a rearwardly directed fixing strip 44. The end of the fixing strip is enclosed by a gripping strip 45 which for this purpose includes a corresponding groove. The gripping strip 45 is connected with the housing 20 of the picking unit 9 by screw bolts. The connecting point is located at the rear upper end of the housing 20. The screw bolts extend in horizontal direction.

For assembly of a picking unit 9 the gripping strip 42 can be connected with the housing 20. The unit produced thereby can be hung into the supporting strip 41. Subsequently, the housing 20 can be pivoted about the supporting strip 41 in anti-clockwise direction, until the position shown in FIG. 5a is reached, at which the rear upper end of the housing 20 rests against a stop 46 which is located in front of the fixing strip 44. In this position, the gripping strip 45 can be positioned from the rear and be fixed at the housing 20 by the screw bolts.

In the housing 20 the drives for the draw-in rollers 26, 27, the draw-in chains 13, the cutting knives 17 of the horizontal chopper 16 and the cutting knives 19 of the vertical chopper 18 are arranged. The input shaft 50 drives the drive for the draw-in rollers 26, 27, the input shaft 51 the drive for the draw-in chains 13, and the input shaft 52 the drives for the cutting knives 17 of the horizontal chopper 16 and the cutting knives 19 of the vertical chopper 18.

FIGS. 6 and 7 show the drive of the input shafts 50, 51, 52. For this purpose, a primary gear 53 is provided. The primary gear 53 is arranged behind the side wall 2 of the frame 1. It is attached to a front side of the frame 1, namely to the side box 4. The attachment of the primary gear 43 is effected on the side wall of the side box 4 directed to the inside.

The primary gear 53 is driven by an input shaft 54. The input shaft 54 extends behind the side wall 2 of the frame 1 in horizontal direction. It is connected with a drive of the combine-harvester. The three output shafts 55, 56, 57 of the primary gear 53 likewise extend in horizontal direction. They surround the input shaft 54.

By the output shafts 55, 56, 57 of the primary gear 53 belt drives are driven, which are located in the side box 4. The output shafts of these belt drives are connected with the input shafts 50, 51, 52 for the draw-in rollers 26, 27, the draw-in chains 13 and the cutting knives 17, 19. By the primary gear 53, which is designed as four-speed manual transmission with three output stages, the input shafts 50, 51, 52 and hence the draw-in rollers 26, 27, the draw-in chains 13 and the cutting knives 17, 19 can be driven independently. The drives for the draw-in rollers 26, 27, the draw-in chains 13 and the cutting knives 17, 19 are adjustable independently. It thereby is possible to adapt the speeds of the draw-in rollers 26, 27, the draw-in chains 13 and the cutting knives 17, 19 to the harvesting conditions and/or the different varieties and stocks. The adjustment of the drives can be effected centrally at the primary gear 53.

The input shafts 50, 51, 52 extend below and in front of the bottom wall 3 of the frame 1. Furthermore, the input shafts 50, 51, 52 of adjacent picking units 9 are connected with each other. At each end of the frame 1 a side box 4 with a primary gear 53 and belt drives is arranged. The picking units 9 on the left half of the frame 1 are driven by the primary gear 53 on the left side box 4, the picking units 9 on the right half of the frame 1 by the primary gear 53 on the right side box 4.

1. A picking unit for corn or the like for a harvesting attachment for a harvesting machine with a picking gap (10) on which two counter-rotating draw-in rollers (26, 27) are arranged,
wherein one draw-in roller (26) has a portion (28) with a spiraling cutting edge (29).

2. The picking unit according to claim 1, wherein the other draw-in roller (27) has a portion (30) with a spiraling cutting edge (31) or with a spiraling strip (34).

3. The picking unit according to claim 2, wherein the cutting edge (29) and the other cutting edge (31) or the strip (34) penetrate each other.

4. The picking unit according to claim 2, wherein between the portions (33) of the spiraling strip (34) of the other draw-in roller (27) flutings (35) are present.

5. The picking unit according to claim 1, wherein one or both of the draw-in rollers (26, 27) have a smooth draw-in region (36).

6. The picking unit according to claim 1, wherein one or both of the draw-in rollers (26, 27) have a draw-in region (36) with spiraling strip (37).

7. The picking unit according to claim 1, wherein the draw-in region (36) of one or both of the draw-in rollers (26, 27) is designed cone-shaped.

8. A harvesting attachment for a harvesting machine with a frame (1), having one or more picking units according to claim 1.

9. A harvesting machine, in particular combine-harvester, having a harvesting attachment according to claim 8.

10. The picking unit according to claim 3, wherein between the portions (33) of the spiraling strip (34) of the other draw-in roller (27) flutings (35) are present.

11. The picking unit according to claim 10, wherein one or both of the draw-in rollers (26, 27) have a smooth draw-in region (36).

12. The picking unit according to claim 4, wherein one or both of the draw-in rollers (26, 27) have a smooth draw-in region (36).

13. The picking unit according to claim 3, wherein one or both of the draw-in rollers (26, 27) have a smooth draw-in region (36).

14. The picking unit according to claim 2, wherein one or both of the draw-in rollers (26, 27) have a smooth draw-in region (36).

15. The picking unit according to claim 14, wherein one or both of the draw-in rollers (26, 27) have a draw-in region (36) with a spiraling strip (37).

16. The nicking unit according to claim 13, wherein one or both of the draw-in rollers (26, 27) have a draw-in region (36) with a spiraling strip (37).

17. The picking unit according to claim 12, wherein one or both of the draw-in rollers (26, 27) have a draw-in region (36) with a spiraling strip (37).

18. The picking unit according to claim 11, wherein one or both of the draw-in rollers (26, 27) have a draw-ire region (36) with a spiraling strip (37).

19. The picking unit according to claim 10, wherein one or both of the draw-in rollers (26, 27) have a draw-in region (36) with a spiraling strip (37).

20. The picking unit according to claim 5, wherein one or both of the draw-in rollers (26, 27) have a draw-in region (36) with a spiraling strip (37).
